(19) United States
(12) Patent Application Publication
(10) Pub. No.: US 2025/0198765 A1
(43) Pub. Date: Jun. 19, 2025

(54) METHOD FOR FILTERING MEASUREMENT DATA FOR A PATH-FOLLOWING CONTROL OF AN OBJECT

(71) Applicant: Robert Bosch GmbH, Stuttgart (DE)

(72) Inventors: Tobias Schwan, Renningen (DE); Ullrich Sussek, Oberstenfeld (DE); Ulrich Bauer, Markgroeningen (DE); Ulrich Laible, Ludwigsburg (DE)

(21) Appl. No.: 18/849,786

(22) PCT Filed: Jul. 11, 2023
(86) PCT No.: PCT/EP2023/069161

§ 371 Date: Sep. 23, 2024

(30) Foreign Application Priority Data
Jul. 12, 2022 (DE) 10 2022 207 104.2

(51) Int. Cl. G01C 21/26; B62D 15/02; G05D 1/646; G06T 7/207

(52) U.S. Cl. CPC G01C 21/26; G05D 1/646; G06T 7/207; B62D 15/025; G06T 2207/10028; G06T 2207/30241; G06T 2207/30252

(57) ABSTRACT

A method for filtering measurement data for a path-following control of an object is provided. The method includes: acquiring measurement data of a portion of a trajectory along which the object is to move, the measurement data including a plurality of point coordinates, which are subject to local fluctuations, and thereby form a point cloud; weighting the plurality of point coordinates by assigning them each different weighting factors, the different weighting factors each specifying the possible fluctuations of the individual point coordinates of the point cloud, at least one point coordinate in an immediate vicinity of the object being fixed by assigning a weighting factor of smaller magnitude to the point coordinate than to a point coordinate at a distance from the object; and performing the filtering for all point coordinates of the point cloud based on the different weighting factors for the path-following control of the object.

### FIELD

The present invention relates to a method for filtering measurement data for a path-following control of an object, in particular a vehicle. Furthermore, the present invention relates to a system for filtering, to a control unit carrying out the proposed method, and to a method for controlling an object, which in particular forms a vehicle.

### SUMMARY

It is an object of the present invention to specify an improved method for filtering measurement data for a path-following control of an object, in particular a vehicle, as well as an optimized system for filtering measurement data.

This object may be achieved by certain features of the present invention. Embodiment examples of the present invention are disclosed herein.

According to the present invention, a method for filtering measurement data for a path-following control of an object, in particular a vehicle, is provided. According to an example embodiment of the present invention, the method comprises the following steps:
acquiring measurement data of at least one portion of a trajectory along which the object is to move, wherein the measurement data comprise a plurality of point coordinates, which are each subject to fluctuations, in particular local fluctuations, and thereby form a point cloud,
weighting the plurality of point coordinates by assigning them each different weighting factors, wherein the different weighting factors each specify fluctuations of the individual point coordinates of the point cloud, wherein at least one point coordinate in an immediate vicinity of the object is fixed by assigning a weighting factor of smaller magnitude to this point coordinate than to a point coordinate at a distance from the object, and
performing the filtering for all point coordinates of the point cloud on the basis of the different weighting factors for the path-following control of the object.

The provided method according to the present invention is advantageously not limited to the use case of the path-following control or path-following function for a vehicle, but can alternatively also be used for other objects, e.g., robots, etc., that are subject to a path-following control. In addition, the proposed method improves the stability, i.e., provides, for example, for a lateral control that is smoother but still flexible within certain limits, and thus for a smooth, i.e., non-jerky, driving behavior. The certain limits are required, for example, since a camera as a sensor for acquiring the measurement data provides more precise point coordinates as measurement data, the closer the vehicle is to its destination.

Conventional methods for filtering measurement data for a path-following control of a vehicle are based on the fact that no weighting of the plurality of point coordinates by assigning them different weighting factors takes place. All point coordinates are filtered equally in this case. However, since all point coordinates have fluctuations that correspond in particular to local or spatial fluctuations and can be more or less pronounced, it is necessary to filter the point coordinates while taking into account a possible varying fluctuation or varying noise. In this case, fixing the point coordinate in the immediate vicinity of the object can mean, for example, that the point moves less and that the interfering influence is amplified less (stronger attenuation of interference signals) than for the point coordinates at a distance from the object (interfering influence is amplified more and attenuation of interference signals is weaker), which move more, for example.

By fixing the point coordinate in the immediate vicinity of the object, it is also possible to track how the camera positions the vehicle relative to this point and the remaining point coordinates are then “funneled” via the filtering rule described below. The trajectory is, for example, recorded by the camera (and may be specified), and the camera calculates a destination (point coordinate at a distance from the object, for example) at which the vehicle is to be parked, for example. This destination can be used by the camera, for example, as the coordinate origin of a (location) coordinate system. The point coordinates output by the camera on an ongoing basis are then used, for example, as location coordinates for the trajectory to be moved along or the at least one portion of the trajectory and are each saved in a memory unit of the camera until the next point coordinate is driven over.

Using the method according to the present invention, the vehicle or object can be moved in a stable and safe manner along the at least one portion of the trajectory because the fact that a point coordinate that lies at a distance from the object, i.e., the vehicle, can still be adjusted better or more simply than a point coordinate that lies in the immediate vicinity of the vehicle is advantageously utilized.

In a further embodiment of the present invention, as the object moves, the at least one point coordinate at a distance from the object moves in order to substantially form the at least one point coordinate in the immediate vicinity of the object after the object has traversed the at least one portion of the trajectory. This advantageously ensures that the object, in particular the vehicle, moves along the at least one portion of the trajectory and reaches its destination. The camera as a sensor continuously transmits a plurality of point coordinates of the trajectory as the object, in particular the vehicle, moves along the at least one portion of the trajectory. That is to say, after the object, in particular the vehicle, drives over a first point coordinate, it transmits, for example, new measurement data with point coordinates starting with the second point coordinate, etc.

In a further example embodiment of the present invention, the filtering is performed on the basis of the different weighting factors for all point coordinates of the point cloud according to the following filtering rule x_{filt i} (k)

$${x}_{filt i} ( k ) = \frac{( {F}_{n i} \cdot {x}_{i} ( k ) ) + ( {F}_{0} \cdot {x}_{filt i} ( k - 1 ) )}{{F}_{n i} + {F}_{0}}$$

where x denotes the point coordinates to be filtered, each comprising an x coordinate and a y coordinate, and also comprises at least the further parameters of target curvature and object orientation,
where i corresponds to an index of the point coordinates and Fₙᵢ corresponds to an assigned weighting factor, and
where F₀ specifies the weighting factor for the previous cycle in performing the filtering.

The provided filtering rule takes into account the weighting of the individual point coordinates in a simple manner and, as a weighted filter, represents a reliable instrument for the path-following control of the object, in particular the vehicle, which is subsequent to the filtering. In particular, the above-mentioned balance between stable point coordinates, and thus a smooth lateral control, and a certain drift of the point coordinates can be achieved in an advantageous manner using the filtering rule of the weighted filter. For example, the parameters of target curvature and object orientation may be specified and may not have been acquired by the sensor, in particular the camera.

In a further example embodiment of the present invention, the filtering of the point coordinates according to the filtering rule x_{filt i} (k) is implemented by means of a PT1 filter. Advantageously, the method offers excellent compatibility with established techniques. The PT1 filter substantially corresponds to a low-pass filter that can reliably filter out high-frequency signals, for example a high-frequency tremor or jerking motion of the steering wheel of a vehicle as it drives along the at least one portion of the trajectory. Alternatively, the use of a mean filter in combination with the proposed method would also be possible. The proposed method can thus be used with the conventional filters in a flexible and resource-conserving manner since it does not require complicated adjustment to the particular filter.

In a further example embodiment of the present invention, the filtering by means of the filtering rule is performed more strongly for the at least one point coordinate in the immediate vicinity of the object than for the at least one point coordinate at a distance from the object. This may advantageously help to individually take into account the plurality of point coordinates subject to fluctuations, i.e., statistical errors/noise, and thus to create a stable input variable for the lateral regulator and to make possible smooth driving behavior overall.

In a further example embodiment of the present invention, the object is designed as a vehicle. This can advantageously make stable lateral control, i.e., stable steering of the vehicle, possible.

In a further example embodiment of the present invention, the measurement data 12 comprise point coordinates that each substantially have a distance of 30 cm. The method explained above can be implemented as simply as possible in this way. For example, the measurement data may each cover a distance in the range of about 3.5 to 4.5 m. Alternatively, deviating values are also possible, depending on the user requirement or sensor used.

Furthermore, a system for filtering measurement data is provided for a path-following control of an object, in particular a vehicle. The system comprises at least one sensor, in particular a camera, for acquiring the measurement data of at least one portion of a trajectory along which the object is to move. The measurement data comprise a plurality of point coordinates, which are each subject to fluctuations, in particular local fluctuations, and thereby form a point cloud. Furthermore, the proposed system comprises a control unit communicatively connected to the at least one sensor and designed to carry out the proposed method for filtering measurement data.

Advantageously, according to an example embodiment of the present invention, the measurement data are acquired by the sensor, in particular a camera, every 120 ms. Accordingly, every 120 ms, the control unit receives a new set of measurement data from the sensor and can apply the above-suggested method for filtering the measurement data to the new set. For example, the camera as a sensor may comprise a memory unit in which the measurement data remain stored for some time until a new set of measurement data is saved in the memory unit. This is possible since the path-following control can, for example, take place at low speeds in the range of about 4 to 5 km/h over the above-mentioned distance of the point coordinates.

Furthermore, according to an example embodiment of the present invention, a control unit is provided, which is designed to carry out the method according to the present invention for filtering measurement data and, based thereon, to perform a path-following control of an object. For example, the control unit may be designed as a parking control unit in an autonomous or semi-autonomous vehicle as the object. Alternative configurations are also possible.

In addition, a method for a path-following control of an object is provided according to the present invention. According to an example embodiment of the present invention, the object comprises at least one sensor, at least one actuator and at least one control unit, wherein the object is in particular designed as a vehicle, and the method comprises the following steps:
acquiring, by the at least one sensor, measurement data of at least one portion of a trajectory along which the object, in particular the vehicle, is to move,
wherein the measurement data comprise a plurality of point coordinates, which are each subject to fluctuations, in particular local fluctuations,
processing, by the at least one control unit, the measurement data into actuator data, wherein, when processing the measurement data into actuator data, the proposed method for filtering measurement data is carried out in order to reduce the local fluctuations of the point coordinates, and
controlling, by the at least one control unit, the at least one actuator on the basis of the generated actuator data in order to carry out the path-following control of the object, in particular the vehicle.

The path-following control, i.e., the control of the vehicle along the trajectory, can advantageously benefit from the result of the weighted filter, i.e., the above-proposed method for filtering measurement data, in order to make possible as stable and smooth a control as possible, i.e., smooth driving behavior.

The advantageous designs and developments of the present invention explained above disclosed elsewhere herein can be applied individually or in any combination with one another, except in cases of unambiguous dependencies or incompatible alternatives, for example.

The above-described properties, features, and advantages of the present invention and the way in which they are achieved become clearer and more readily comprehensible in connection with the following description of embodiment examples, which are explained in more detail in connection with the schematic figures.

### BRIEF DESCRIPTION OF THE DRAWINGS

FIG. 1 shows a schematic illustration of a system for filtering measurement data, according to an example embodiment of the present invention.

FIG. 2 shows a schematic illustration of a method for filtering measurement data for a path-following control of an object according to a first example embodiment of the present invention.

FIG. 3 shows a schematic illustration of a method for filtering measurement data for a path-following control of an object according to a second example embodiment of the present invention.

FIG. 4 shows a schematic illustration of a method for the path-following control of an object, according to an example embodiment of the present invention.

### DETAILED DESCRIPTION OF EXAMPLE EMBODIMENTS

It is pointed out that the figures are merely schematic in nature and not to scale. In this sense, components and elements shown in the figures may be shown exaggeratedly large or reduced in size for better understanding. It is furthermore pointed out that the reference signs in the figures have been selected to be unchanged for elements and/or components that are designed identically.

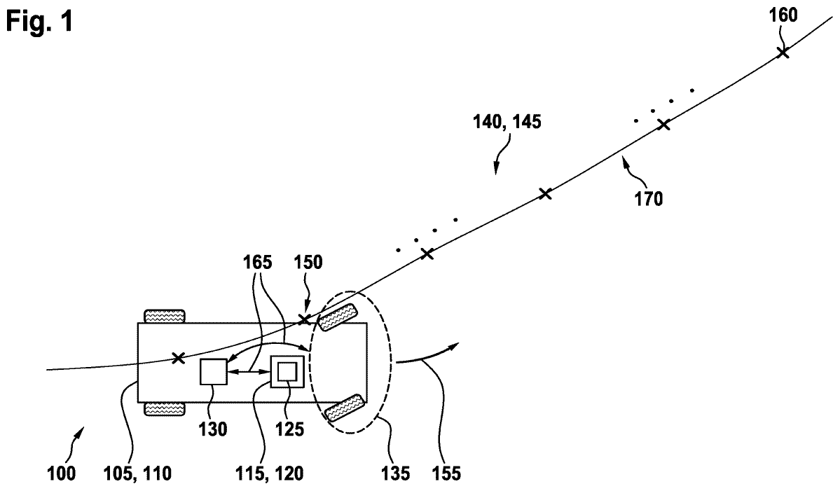

FIG. 1 shows a schematic illustration of a system 100 for filtering measurement data 140 for a path-following control of an object 105. The object 105 in the illustrated example is designed as a vehicle 110. Alternatively, the object 105 can also be designed in the form of a robot, or the like. In the following, the terms object 105 and vehicle 110 are used in some cases as synonyms. For example, the vehicle 110 may be an autonomous or semi-autonomous vehicle 110. The vehicle 110 comprises at least one sensor 115 for acquiring the measurement data 140 of at least one portion of a trajectory 170 along which the vehicle 110 is to move. This sensor is designed in the form of a camera 120 in FIG. 1, for example. Further or alternative sensors 115 are also possible, such as a LIDAR sensor, radar sensor, etc. The camera 120 comprises at least one internal memory unit 125 in which the measurement data 140 may be stored. At least one external memory unit may also be used in an alternative configuration to store the measurement data 140.

The acquired measurement data 140 of the at least one portion of the trajectory 170 along which the vehicle 110 is to move comprise a plurality of point coordinates 145. Here, a direction of movement 155 of the object 105, i.e., the vehicle 110, is indicated by the arrow in FIG. 1. The point coordinates 145 are each subject to fluctuations (or noise or a statistical error or a jitter). In particular, the fluctuations may correspond to local or spatial fluctuations. This creates a point cloud. The vehicle 110 comprises at least one actuator 135 for the path-following control of the vehicle 110. For example, the at least one actuator 135 may correspond to a steering unit or a lateral regulator in order to realize steering movement of the vehicle 110. A method for path-following control 400 is explained in connection with FIG. 4. The at least one sensor 115, i.e., for example, the camera 120, and the at least one actuator 135, i.e., for example, the lateral regulator, are communicatively connected to a control unit 130. For example, the control unit 130 may be a parking control unit of the vehicle 110. Alternative configurations are also possible in this regard. The control unit 130 is designed to carry out a method 200, 300 for filtering measurement data 140 and/or to control the at least one actuator 135 according to the method for the path-following control 400 of the vehicle 110, in order to perform the path-following control accordingly.

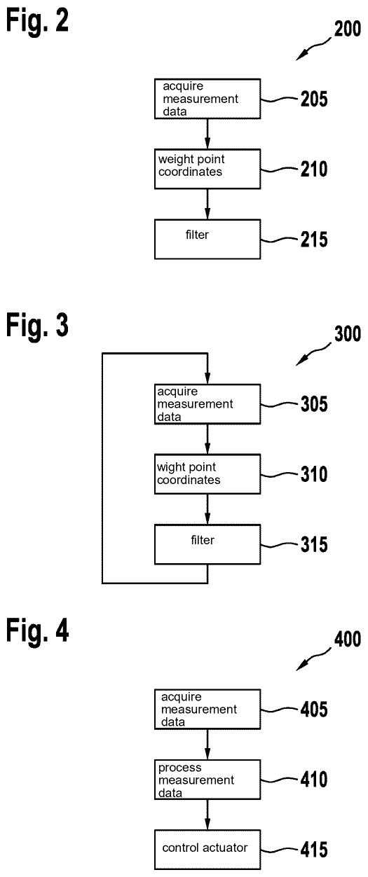

In the following, FIGS. 2 to 4 are each explained in combination with FIG. 1. FIG. 2 shows a schematic illustration of a first embodiment of a method 200 for filtering measurement data 140 for the path-following control of an object 105, i.e., a vehicle 110. The method 200 comprises, in a first step 205, acquiring measurement data 140 of the at least one portion of the trajectory 170 in FIG. 1 along which the vehicle 110 is to move. The measurement data 140 comprise the plurality of point coordinates 145, which are subject to local fluctuations, as explained at the beginning. The plurality of point coordinates 145 can thus form location coordinates.

In a second step 210 of the method 200, the plurality of point coordinates 145 are weighted by assigning them each different weighting factors. Here, the different weighting factors may each specify fluctuations of the individual point coordinates 145.

At least one point coordinate is fixed in an immediate vicinity 150 of the vehicle 110 in the second step 210 by assigning a weighting factor of smaller magnitude to this point coordinate than to a point coordinate at a distance from the object 160. In other words, this means that the scatter/fluctuation of the point coordinates at a distance 160 from the vehicle 110 is greater (i.e., the interfering influence is amplified more) than that of the point coordinates in the vicinity 150 of the vehicle 110 (i.e., the interfering influence is amplified less). The point coordinate in the vicinity 150 of the vehicle is thus stable, while the other point coordinates at a distance 160 may be more likely to be varied or adjusted.

Finally, in a third step 215, the filtering is performed for all point coordinates 145 on the basis of the different weighting factors for the path-following control of the vehicle 110.

Filtering in the third step 215 is, for example, performed using the following filtering rule x_{filt i} (k)

$${x}_{filt i} ( k ) = \frac{( {F}_{n i} \cdot {x}_{i} ( k ) ) + ( {F}_{0} \cdot {x}_{filt i} ( k - 1 ) )}{{F}_{n i} + {F}_{0}}$$

where x denotes the point coordinates to be filtered, each comprising an x coordinate and a y coordinate, and also comprises at least the further parameters of target curvature and object orientation,
where i corresponds to an index of the point coordinates 145 and Fₙᵢ corresponds to an assigned weighting factor, and
where F₀ specifies the weighting factor for the previous cycle in performing the filtering. The index i of the point coordinates 145 in the example below can run from 1 to 12, provided that the camera 120 as the sensor 115, for example, acquires 12 location coordinates in each case, wherein the points can each have a distance of approximately 30 cm, for example. Alternative values are equally possible.

The above-mentioned filtering with the filtering rule x_{filt i} (k) may, for example, be implemented by means of a PT1 filter, i.e., a low-pass filter, which forms a resistor-capacitor combination in the simplest approximation. Examples of weighting factors Fₙᵢ for the 12 point coordinates (labeled P₂) are given in the table below:

| | | Filtering [%] |
|---|---|---|
| Pᵢ | Fₙᵢ | at F₀ = 50 |
| 1 | 1 | 2 |
| 2 | 2 | 4 |
| 3 | 4 | 7 |
| 4 | 6 | 11 |
| 5 | 8 | 14 |
| 6 | 10 | 17 |
| 7 | 12 | 19 |
| 8 | 14 | 22 |
| 9 | 16 | 24 |
| 10 | 18 | 26 |
| 11 | 20 | 28 |
| 12 | 22 | 30 |

It is understood that the values specified are merely exemplary in nature. The table shows that the filtering for the point coordinate P1 assumed to be in the vicinity 150 of the vehicle 110 (an interference signal is amplified by 2% or attenuated by a factor of 200) is stronger than the filtering for the point coordinate P12, i.e., for example, at a distance 160 from the vehicle 110, (an interference signal is amplified by 30% or attenuated by a factor of 30). The proposed method 200 thus allows for a kind of funneling, which results in stable point coordinates 145 in the immediate vicinity of the vehicle 110, 150. Smooth transverse control and thus steering can thereby be achieved for the method 400 for path-following control.

In particular, the filtering rule x_{filt i} (k) according to the above equation and the table provided results in the filtering being repeated. This is shown schematically in FIG. 3 in the method for filtering measurement data according to a second embodiment 300. A first method step 305, a second method step 310 and a third method step 315 may be designed similarly to the first method step 205, the second method step 210 and the third method step 215 in FIG. 2; reference is therefore made to the above explanation. The return from the third method step 315 to the first method step 305 indicates that measurement data are acquired and filtered continuously. This is because, as the vehicle 110 moves, the at least one point coordinate at a distance 170 from the vehicle 110 moves in order to form the at least one point coordinate in the immediate vicinity 150.

Finally, FIG. 4 shows a method 400 for the path-following control of an object 105, wherein the object 105 is again designed as a vehicle 110, for example. The vehicle 110 may, for example, be designed analogously to the above explanation of FIG. 1. Therefore, only the individual method steps of the method 400 are explained below. In a first step 405, measurement data 140 of at least one portion of a trajectory 170 are acquired by means of a sensor 115 (analogously to the first steps 205 and 305 in FIGS. 2 and 3). The sensor 115 may in turn be designed as a camera 120. In a second step 410, the control unit 130 is designed to process the measurement data 140 into actuator data while carrying out the method for filtering measurement data 200, 300 with the features mentioned in connection with FIGS. 2 and 3, in order to reduce the local fluctuations of the point coordinates 145 comprising the measurement data 140 and, in this way, to make possible stable values for the input of the lateral regulator as the actuator 135, for example. Finally, (step 415) the actuator 135 is controlled on the basis of the generated actuator data, and the path-following control of the vehicle 110 is thus performed.

The present invention has been described in detail by preferred embodiment examples. In lieu of the described embodiment examples, further embodiment examples are possible, which may comprise further modifications or combinations of described features. For this reason, the present invention is not limited by the disclosed examples since other variations may be derived therefrom by a person skilled in the art without departing from the present invention.

1-10. (canceled)

11. A method for filtering measurement data for a path-following control of an object, wherein the method comprises the following steps:
acquiring measurement data of at least one portion of a trajectory along which the object is to move, wherein the measurement data include a plurality of point coordinates which are each subject to local fluctuations and thereby form a point cloud;
weighting the plurality of point coordinates by assigning them each different weighting factors, wherein the different weighting factors each specify fluctuations of the point coordinates of the point cloud, wherein at least one point coordinate is fixed in an immediate vicinity of the object by assigning a weighting factor of smaller magnitude to the at least one point coordinate than to a point coordinate at a distance from the object; and
performing the filtering for all point coordinates of the point cloud based on the different weighting factors for the path-following control of the object.

12. The method according to claim 11, wherein, as the object moves, the at least one point coordinate at a distance from the object moves in order to substantially form the at least one point coordinate in the immediate vicinity of the object after the object has traversed the at least one portion of the trajectory.

13. The method according to claim 11, wherein the filtering is performed based on the different weighting factors for all point coordinates of the point cloud according to the following filtering rule x_{filt i} (k)
$${x}_{filt i} ( k ) = \frac{( {F}_{n i} \cdot {x}_{i} ( k ) ) + ( {F}_{0} \cdot {x}_{filt i} ( k - 1 ) )}{{F}_{n i} + {F}_{0}}$$
where x denotes the point coordinates to be filtered, each including an x coordinate and a y coordinate, and also included at least further parameters of target curvature and object orientation, where i corresponds to an index of the point coordinates and Fₙᵢ corresponds to an assigned weighting factor, and where F₀ specifies the weighting factor for a previous cycle in performing the filtering.

14. The method according to claim 13, wherein the filtering of the point coordinates according to the filtering rule x_{filt i} is implemented using a PT1 filter.

15. The method according to claim 13, wherein the filtering using the filtering rule is performed more strongly for the at least one point coordinate in the immediate vicinity of the object than for the at least one point coordinate at a distance from the object.

16. The method according to claim 11, wherein the object is a vehicle.

17. The method according to claim 11, wherein the measurement data include 12 point coordinates, which each substantially have a distance of 30 cm.

18. A system configured to filter measurement data for a path-following control of an object, comprising:
at least one sensor including a camera, configured to acquire the measurement data of at least one portion of a trajectory along which the object is to move, wherein the measurement data include a plurality of point coordinates, which are each subject to local fluctuations, and form a point cloud;
a control unit communicatively connected to the at least one sensor and configured to:
weight the plurality of point coordinates by assigning them each different weighting factors, wherein the different weighting factors each specify fluctuations of the point coordinates of the point cloud, wherein at least one point coordinate is fixed in an immediate vicinity of the object by assigning a weighting factor of smaller magnitude to the at least one point coordinate than to a point coordinate at a distance from the object; and
perform the filtering for all point coordinates of the point cloud based on the different weighting factors for the path-following control of the object.

19. A control unit configured to filter measurement data for a path-following control of an object, wherein the control unit configured to:
acquire measurement data of at least one portion of a trajectory along which the object is to move, wherein the measurement data include a plurality of point coordinates which are each subject to local fluctuations and thereby form a point cloud;
weight the plurality of point coordinates by assigning them each different weighting factors, wherein the different weighting factors each specify fluctuations of the point coordinates of the point cloud, wherein at least one point coordinate is fixed in an immediate vicinity of the object by assigning a weighting factor of smaller magnitude to the at least one point coordinate than to a point coordinate at a distance from the object; and
perform the filtering for all point coordinates of the point cloud based on the different weighting factors for the path-following control of the object.

20. A method for path-following control of an object including at least one sensor, at least one actuator, and at least one control unit, wherein the object is a vehicle, the method comprising the following steps:
acquiring, by the at least one sensor, measurement data of at least one portion of a trajectory along which the vehicle is to move, wherein the measurement data include a plurality of point coordinates, which are each subject to local fluctuations and thereby form a point cloud;
processing, by the at least one control unit, the measurement data into actuator data, wherein, when processing the measurement data into actuator data, wherein, for filtering the measurement data, the following steps are performed to reduce the local fluctuations of the point coordinates:
weighting the plurality of point coordinates by assigning them each different weighting factors, wherein the different weighting factors each specify fluctuations of the point coordinates of the point cloud, wherein at least one point coordinate is fixed in an immediate vicinity of the object by assigning a weighting factor of smaller magnitude to the at least one point coordinate than to a point coordinate at a distance from the object; and
performing the filtering for all point coordinates of the point cloud based on the different weighting factors for the path-following control of the object; and
controlling, by the at least one control unit, the at least one actuator based on the generated actuator data to carry out the path-following control of the vehicle.
